(19) United States
(12) Patent Application Publication
(10) Pub. No.: US 2026/0361450 A1
(43) Pub. Date: Nov. 12, 2026

(54) SYSTEMS, APPARATUSES AND METHODS FOR PAUSING AND RESUMING TRANSMISSIONS IN A WIRELESS NETWORK

(71) Applicant: HUAWEI TECHNOLOGIES CO., LTD., SHENZHEN (CN)

(72) Inventors: Abdalla Mohamed Abdelaziz Mahmoud HUSSEIN, Kanata (CA); Mahmoud HASABELNABY, Kanata (CA); Osama ABOUL-MAGD, Kanata (CA); Jung Hoon SUH, Kanata (CA); Yan XIN, Kanata (CA)

(73) Assignee: HUAWEI TECHNOLOGIES CO., LTD., SHENZHEN (CN)

(21) Appl. No.: 19/204,029

(22) Filed: May 9, 2025

(51) Int. Cl. H04L 1/00

(52) U.S. Cl. CPC H04L 1/0018

(57) ABSTRACT

A method and apparatus for pausing and resuming of an ongoing transmission in a wireless network is provided. A transmitting device may pause an ongoing transmission to the receiving device(s) and transmit a transmission pause indication, and may resume the paused ongoing transmission and transmit a transmission resume indication. The ongoing transmission may be paused in response to a triggering event, such as a low latency transmission. An additional device that has a low latency transmission, for the transmitting device or one of the receiving devices, may transmit a transmission pause request to an access point (AP). The AP that is the transmitting device can pause the ongoing transmission to receive the priority transmission and resume the ongoing transmission thereafter. The AP that is the receiving device can transmit a transmission pause command and, after receiving the priority transmission, can transmit a transmission resume command to resume the ongoing transmission.

### CROSS-REFERENCE TO RELATED APPLICATIONS

This application first application associated with the present disclosure.

### FIELD OF THE DISCLOSURE

The present disclosure relates generally to wireless communication systems, apparatuses, methods, and non-transitory computer-readable storage devices, and in particular to systems, apparatuses and methods for supporting pausing and resuming of ongoing communications in wireless communication systems.

### BACKGROUND

Wireless communication systems such as IEEE 802.11 standard series (that is, Wi-Fi® series; Wi-Fi® is a registered trademark of Wi-Fi® Alliance, Austin, TX, USA) are known. In the recent IEEE 802.11bn standard . . .

Low latency (LL) support has emerged as a key requirement in recent IEEE considerations, such as IEEE 802.11-22/1919r4 dated Jan. 17, 2023, for ultra high reliability (UHR) wireless networks and the forthcoming generations of IEEE 802.11 standards can include corresponding standardization. This focus is driven at least in part by the rising demand for real-time applications that require near-instantaneous response times. Advanced services such as virtual reality (VR), extended reality (XR), factory automation, smart grids, and remote surgery depend heavily on rapid communication with minimal delays to ensure a seamless user experience. The stringent latency requirements of these applications are pushing the boundaries of current wireless technologies, making the enhancement of LL support essential for enabling next-generation services.

In light of these demands, there is need for improvements in LL communications. A recently passed IEEE motion 802.11-25/0014r7 dated Jan. 16, 2025 underscores the industry's interest in solutions addressing LL challenges that that can be introduced as standardized protocol mechanisms enabling devices, such as access points (APs), to approach low latency traffic effectively.

Therefore, there is a need for a method, apparatus and system for wireless communication that obviates or mitigates one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

According to an aspect of the present disclosure, there is provided a method that includes transmitting, by a first device in a wireless network to a second device in the wireless network. The transmission pause indication is indicative of pausing, by the first device, an ongoing transmission from the first device to the second device. The method includes resuming, by the first device, the ongoing transmission to the second device.

According to embodiments, the ongoing transmission may include a physical layer protocol data unit (PPDU), pausing the ongoing transmission may include pausing transmission of the PPDU, and resuming the ongoing transmission may include resuming the transmission of the PPDU.

According to embodiments, the transmission pause indication may include an orthogonal frequency-division multiplexing (OFDM) symbol or an orthogonal frequency-division multiple access (OFDMA) symbol having a predefined sequence.

According to embodiments, the method may include receiving a transmission pause request from a third device in the wireless network, receiving a transmission pause request from the third device via the second device, and receiving a transmission pause command from the second device. For example, the pause request may be received via either a cross-link, a dedicated RU, or piggybacked on the next transmission (e.g. PPDU or ACK which may be a BA or a multi-STA BA).

According to embodiments, the method may include receiving a transmission resume command from the second device.

According to embodiments, the transmission pause indication may follow a first portion of the ongoing transmission transmitted by the first device to the second device. Resuming the ongoing transmission may include transmitting a transmission resume indication followed by a second portion of the ongoing transmission, the second portion being subsequent to the first portion. Resuming the ongoing transmission may further include retransmitting a predetermined portion of the first portion, the predetermined portion immediately preceding the second portion. The transmission resume indication may include one of: the transmission pause indication; a value of 1 of bit B8 of a U-SIG-2 field of a physical layer (PHY) Header for transmitting the second portion of the ongoing transmission; and a predefined value of a bit selected from bits B20 through B25 of a U-SIG-1 field of the PHY Header for transmitting the second portion of the ongoing transmission.

According to embodiments, the method may include determining that a triggering event requires the pausing, by the first device, of the ongoing transmission from the first device to the second device. Determining that a triggering event requires the pausing, by the first device, of the ongoing transmission from the first device to the second device, may include receiving a triggering event indication from the second device or from a third device in the wireless network. The triggering event may be one or more of a low latency (LL) traffic to be received by the first device, a low latency (LL) traffic to be received by the second device, computing resources at the first device being below a predetermined threshold, and computing resources at the first device being unavailable, or a dynamic unavailability or coexistence requirement. The method may include determining, at the first device, that the triggering event is complete, and resuming of the ongoing transmission may follow the completion of the triggering event.

According to another aspect of the present disclosure, there is provided a method that includes receiving, by a first device in a wireless network from a second device in the wireless network, a first portion of an ongoing transmission and a transmission pause indication immediately following the first portion. The transmission pause indication is indicative of pausing, by the second device, the ongoing transmission from the second device to the first device. The method includes storing the first portion in a memory of the first device and receiving, by the first device from the first device, a second portion of the ongoing transmission.

According to embodiments, the method may include combining, at the first device, the first portion and the second portion to obtain a complete transmission.

According to embodiments, receiving the second portion may include receiving a transmission resume indication that precedes the second portion, the transmission resume indication being one of: the transmission pause indication; a predetermined portion of the first portion, the predetermined portion immediately preceding the transmission pause indication; a value of 1 of bit B8 of a U-SIG-2 field of a physical layer (PHY) Header for the second portion of the ongoing transmission; and a predefined value of a bit selected from bits B20 through B25 of a U-SIG-1 field of the PHY Header for the second portion of the ongoing transmission.

According to embodiments, storing the first portion in the memory of the first device may include storing the first portion for a predetermined duration.

According to embodiments, the ongoing transmission may be a physical layer protocol data unit (PPDU).

According to embodiments, the transmission pause indication may include an orthogonal frequency-division multiplexing (OFDM) symbol or an orthogonal frequency-division multiple access (OFDMA) symbol having a predefined sequence.

According to embodiments, the method may include one or more of: transmitting, from the first device to the second device, a block acknowledgement (BA) message that includes a transmission pause request from a third device in the wireless network; receiving the transmission pause request from the third device; and transmitting, from the first device to the second device, a transmission pause command for pausing the ongoing transmission from the second device to the first device.

According to embodiments, the method may include transmitting, from the first device to the second device, a transmission resume command.

According to embodiments, the method may include determining, at the first device, that a triggering event requires the pausing, by the second device, of the ongoing transmission from the second device to the first device. The triggering event may be one or more of: a low latency (LL) traffic to be received by the first device, a low latency (LL) traffic to be received by the second device, computing resources at the second device being below a predetermined threshold, and computing resources at the second device being unavailable or a dynamic unavailability or coexistence requirement at the device. The method may include determining, at the first device, that the triggering event is complete, and the resuming of the ongoing transmission may follow the completion of the triggering event.

According to another aspect of the present disclosure, there is provided an apparatus in a wireless network. The apparatus includes a processor and memory, the memory including machine executable instructions which when executed by the processor configure the apparatus to transmit, by a first device in a wireless network to a second device in the wireless network, a transmission pause indication indicative of pausing, by the first device, an ongoing transmission from the first device to the second device; and resume, by the first device, the ongoing transmission to the second device.

According to embodiments, the ongoing transmission may include a physical layer protocol data unit (PPDU), pausing the ongoing transmission may include pausing transmission of the PPDU, and resuming the ongoing transmission may include resuming the transmission of the PPDU.

According to embodiments, the transmission pause indication may include an orthogonal frequency-division multiplexing (OFDM) symbol or an orthogonal frequency-division multiple access (OFDMA) symbol having a predefined sequence.

According to embodiments, the transmission pause indication may follow a first portion of the ongoing transmission transmitted by the first device to the second device.

According to embodiments, the machine executable instructions when executed by the processor may further configure the apparatus to transmit a transmission resume indication followed by a second portion of the ongoing transmission, the second portion being subsequent to the first portion. The machine executable instructions when executed by the processor may further configure the apparatus to retransmit a predetermined portion of the first portion, the predetermined portion immediately preceding the second portion. The transmission resume indication may include one of: the transmission pause indication, a value of 1 of bit B8 of a U-SIG-2 field of a physical layer (PHY) Header for transmitting the second portion of the ongoing transmission, and a predefined value of a bit selected from bits B20 through B25 of a U-SIG-1 field of the PHY Header for transmitting the second portion of the ongoing transmission.

According to embodiments, the machine executable instructions when executed by the processor may further configure the apparatus to determine that a triggering event requires the pausing, by the first device, of the ongoing transmission from the first device to the second device. The triggering event may be one or more of: a low latency (LL) traffic to be received by the first device, a low latency (LL) traffic to be received by the second device, computing resources at the first device being below a predetermined threshold, and computing resources at the first device being unavailable.

According to embodiments, the machine executable instructions when executed by the processor may further configure the apparatus to determine, at the first device, that the triggering event is complete, and the resuming of the ongoing transmission may follow the completion of the triggering event.

According to another aspect of the present disclosure, there is provided an apparatus in a wireless network. The apparatus includes a processor and memory, the memory including machine executable instructions which when executed by the processor configure the apparatus to receive, at a first device in a wireless network from a second device in the wireless network, a first portion of an ongoing transmission and a transmission pause indication immediately following the first portion, the transmission pause indication indicative of pausing, by the second device, the ongoing transmission from the second device to the first device. The machine executable instructions when executed by the processor configure the apparatus to store the first portion in a memory of the first device. The machine executable instructions when executed by the processor configure the apparatus to receive, at the first device from the first device, a second portion of the ongoing transmission.

According to embodiments, the machine executable instructions when executed by the processor may further configure the apparatus to combine, at the first device, the first portion and the second portion to obtain a complete transmission.

According to embodiments, the ongoing transmission may be a physical layer protocol data unit (PPDU).

According to embodiments, the transmission pause indication may include an orthogonal frequency-division multiplexing (OFDM) symbol or an orthogonal frequency-division multiple access (OFDMA) symbol having a predefined sequence.

According to embodiments, the machine executable instructions when executed by the processor may further configure the apparatus to perform one or more of: transmit, from the first device to the second device, a block acknowledgement (BA) message that includes a transmission pause request from a third device in the wireless network; receive the transmission pause request from the third device; and transmit, from the first device to the second device, a transmission pause command for pausing the ongoing transmission from the second device to the first device.

According to embodiments, the machine executable instructions when executed by the processor may further configure the apparatus to transmit, from the first device to the second device, a transmission resume command.

According to embodiments, the machine executable instructions when executed by the processor may further configure the apparatus to determine, at the first device, that a triggering event requires the pausing, by the second device, of the ongoing transmission from the second device to the first device. The triggering event may be one or more of a low latency (LL) traffic to be received by the first device, a low latency (LL) traffic to be received by the second device, computing resources at the second device being below a predetermined threshold, and computing resources at the second device being unavailable.

According to one aspect of this disclosure, there is provided one or more circuits such as one or more processors for performing the above-described methods.

According to one aspect of this disclosure, there is provided one or more processors functionally connected to one or more memories for performing the above-described methods.

According to one aspect of this disclosure, there is provided an apparatus including one or more processors functionally connected to one or more memories for performing the above-described methods.

According to one aspect of this disclosure, there is provided one or more non-transitory computer-readable storage devices including computer-executable instructions, wherein the instructions, when executed, cause one or more circuits to perform the above-described methods.

According to one aspect of this disclosure, there is provided an apparatus, and configured to perform any one of the above mentioned methods and their embodiments. Specifically, the apparatus includes one or more units configured to perform any one of the above mentioned methods and their embodiments.

According to one aspect of this disclosure, there is provided a computer-readable storage medium. The computer-readable storage medium stores a computer program, and when the computer program is executed by an apparatus, the apparatus is enabled to implement any one of the above mentioned methods and their embodiments.

According to one aspect of this disclosure, there is provided a computer program product including one or more instructions. When the instructions are executed by an apparatus such as a computer, the apparatus is enabled to implement any one of the above mentioned methods and their embodiments.

According to one aspect of this disclosure, there is provided a computer program. When the computer program is executed by a computer, an apparatus is enabled to implement any one of above mentioned methods and their embodiments.

According to one aspect of this disclosure, there is provided a communication system. The communication system includes a first communication-node and/or a second communication-node, the first communication-node is configured to perform the methods regarding with the first communication-node as stated above, and the second communication-node is configured to perform the methods regarding with the second communication-node as stated above.

According to one aspect of this disclosure, there is provided an apparatus for implementing the methods in any possible implementation of the foregoing aspects.

Embodiments have been described above in conjunctions with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present disclosure will become apparent from the following detailed description, taken in combination with the appended drawings, in which:

FIG. 1 is a simplified schematic diagram showing a communication system, according to some embodiments of this disclosure.

FIG. 2 is a simplified schematic diagram of an access point (AP) of the communication network of the communication system shown in FIG. 1.

FIG. 3 is a simplified schematic diagram of a station (STA) of the communication system shown in FIG. 1.

FIG. 4 is a simplified schematic diagram of a transmission in a wireless communication system.

FIG. 5 is a simplified schematic diagram of a paused ongoing transmission in a wireless communication system, according to an embodiment of the present disclosure.

FIG. 6 is a simplified schematic diagram of a resumed ongoing transmission in a wireless communication system, according to an embodiment of the present disclosure.

FIG. 7 is a simplified schematic diagram of an additional user info field that includes a resume offset, according to an embodiment of the present disclosure.

FIG. 8 is a simplified schematic diagram of a universal signal 2 (U-SIG2) field showing the validate bit B8 that may be utilized for a transmission resume indication, according to an embodiment of the present disclosure.

FIG. 9 is a simplified schematic diagram of a universal signal 1 (U-SIG1) field showing bits B20-B25 that may be that may be utilized for a transmission resume indication, according to an embodiment of the present disclosure.

FIG. 10 is a simplified schematic diagram of a resumed ongoing transmission that includes a transmission resume indication after the physical layer (PHY) header, according to an embodiment of the present disclosure.

FIG. 11 is a simplified schematic diagram of a method for pausing and resuming an ongoing transmission, according to an embodiment of the present disclosure.

FIG. 12 is a simplified schematic diagram of a method for pausing and resuming an ongoing transmission, according to another embodiment of the present disclosure.

FIG. 13 is a simplified schematic diagram of a method for pausing and resuming an ongoing transmission, according to another embodiment of the present disclosure.

FIG. 14 is a simplified schematic diagram of a method for pausing and resuming an ongoing transmission, according to another embodiment of the present disclosure.

FIG. 15 is a simplified schematic diagram of a method for pausing and resuming an ongoing transmission, according to another embodiment of the present disclosure.

FIG. 16 is a simplified schematic diagram of a clear to send (CTS)-to-self frame showing to distribution system (To DS) bit and From DS bit that may be utilized for a transmission pause request, according to an embodiment of the present disclosure.

FIG. 17 is a table showing two examples of assigning values to To DS bit and From DS bit to indicate a transmission pause command or a transmission resume command, according to an embodiment of the present disclosure.

FIG. 18 is a simplified schematic diagram of BA control frame showing reserved bits b0 and b5-b8 1812 that may be utilized for a transmission pause request, according to an embodiment of the present disclosure.

FIG. 19 is a simplified schematic diagram of a special info field of a multi-STA block acknowledgment (BA) control frame that may be utilized for a transmission pause request, according to an embodiment of the present disclosure.

FIG. 20 is a simplified schematic diagram of a BA control frame that includes feedback information field that may be utilized for a transmission pause request, according to an embodiment of the present disclosure.

FIG. 21 is a simplified schematic diagram of a management action frame payload that includes a transmission pause request and related information, according to an embodiment of the present disclosure.

FIG. 22 is a simplified schematic diagram of a low latency (LL) parameters field of the management action frame of FIG. 21, according to an embodiment of the present disclosure.

FIG. 23 is a simplified schematic diagram of a management action frame payload that includes a transmission resume command and related information, according to an embodiment of the present disclosure.

FIG. 24 is a simplified schematic diagram of a LL parameters field of the management action frame of FIG. 23, according to an embodiment of the present disclosure.

FIG. 25 is a simplified schematic diagram of a quality of service (QoS) null frame that may be utilized for a transmission resume command, according to an embodiment of the present disclosure.

FIG. 26 is a simplified schematic diagram of a modified trigger frame that may be utilized for a transmission resume command, according to an embodiment of the present disclosure.

FIG. 27 is a simplified schematic diagram of a multi-user request to send (MU-RTS) trigger frame that may be utilized for a transmission resume command, according to an embodiment of the present disclosure.

FIG. 28 is a simplified schematic diagram of a Special STA Info field of a User Info list of a trigger frame, according to an embodiment of the present disclosure.

It will be noted that throughout the appended drawings, like features are identified by like reference numerals.

### DETAILED DESCRIPTION

Embodiments disclosed herein relate to systems, apparatuses, methods, and non-transitory computer-readable storage devices for wireless communication. The wireless communication systems, apparatuses, and methods disclosed herein may be any suitable systems, apparatuses, and methods for transmitting wireless signals. Examples of such systems may be wireless local-area network (WLAN) ultra-high reliability (UHR) systems (for example, IEEE 802.11bn or Wi-Fi® 8 systems and future Wi-Fi® systems), 5^{th} generation (5G) or 6^{th} generation (6G) wireless mobile communication systems, and the like.

This instant disclosure is related to the standardization of next generation of IEEE 802.11bn and later standards for providing an improved quality of service (QoS) to triggering events, such as LL communications. embodiments of the present disclosure are applicable to Wi-Fi® APs and stations (STAs), and in particular, Wi-Fi® 8 devices (e.g. future devices).

Embodiments of the present disclosure pertain to methods, systems and apparatuses for pausing and resuming an ongoing transmission between two devices in a wireless network. Pausing may be initiated in response to a triggering event, such as an indication of an incoming LL traffic, low resources at the sending device or the receiving device, and in device coexistence scenarios, where a STA needs to temporarily disable or pause one of its wireless functionalities, e.g., Wi-Fi® transceiver (TRX) circuitry, to redirect or utilize associated resources (e.g., antennas) for another wireless functionality (e.g., Bluetooth™, Zigbee™, etc.). Pausing the ongoing transmission involves the receiving device storing the already received portion of the ongoing communication, which may be a portion of a physical layer protocol data unit (PPDU) or a portion of an ongoing transmission received during a transmission opportunity (TXOP), in a memory of the receiving device. Resumption of the ongoing transmission involved transmitting a subsequent portion of the ongoing transmission which the receiving device may combine with the previously received portion stored in its memory.

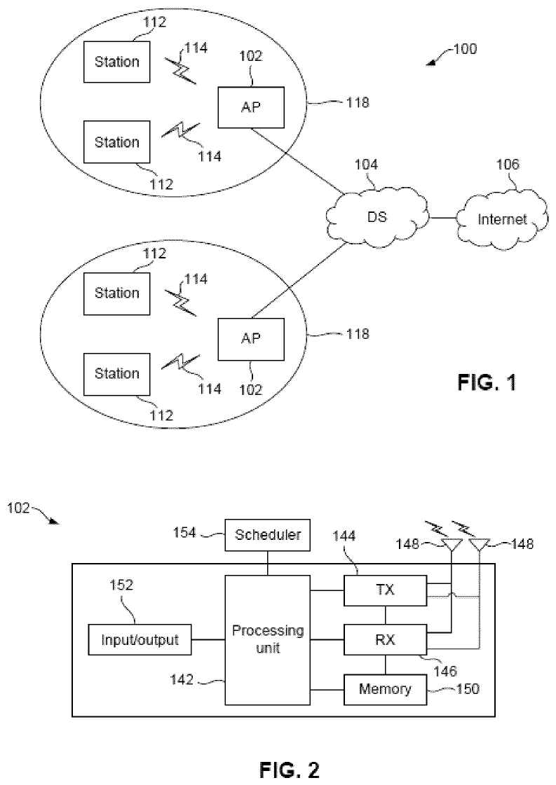

Turning now to FIG. 1, a communication system according to some embodiments of this disclosure is shown and is generally identified using reference numeral 100. As an example, the communication system 100 may be a wireless network such as a Wi-Fi® system built under relevant standards such as IEEE 802.11 standard. As shown, the communication system 100 includes a plurality of interconnected networking devices 102 such as a plurality of interconnected access points (APs; also called “base stations”) forming a distribution system (DS) 104 which is in turn connected to other networks such as the Internet 108 which may include a network of computers and subnets (intranets) or both, and incorporate protocols, such as Internet protocol (IP), transmission control protocol (TCP), user datagram protocol (UDP), and/or the like.

Each AP 102 is in wireless communication with one or more mobile or stationary stations 112 (STAs) through respective wireless channels 114 for providing wireless network connects thereto. Herein, the APs 102 and STAs 112 may be considered as different types of network nodes (or simply “nodes”) of the communication system 100. Each AP 102 and the STAs 112 connected thereto form a cell or basic service set (BSS) 118.

FIG. 2 is a simplified schematic diagram of an AP 102. As shown, the AP 102 includes at least one processing unit 142 (also denoted at least one “processor”), at least one transmitter (Tx) 144, at least one receiver (RX) 146 (collectively referred to as a transceiver), one or more antennas 148, at least one memory 150, and one or more input/output components or interfaces 152. A scheduler 154 may be coupled to the processing unit 142. The scheduler 154 may be included within or operated separately from the AP 102. Each of these components 142 to 154 may be implemented as one or more circuits (such as one or more electronic circuits and/or one or more optical circuits). Alternatively, the ensemble of these components 142 to 154 may be implemented as one or more circuits.

The processing unit 142 Is configured for performing various processing operations such as signal coding, data processing, power control, input/output processing, or any other suitable functionalities. The processing unit 142 may include a microprocessor, a microcontroller, a digital signal processor, a field programmable gate array (FPGA), an application specific integrated circuit (ASIC), and/or the like. In some embodiments, the processing unit 142 may execute computer-executable instructions or code stored in the memory 150 to perform various the procedures (otherwise referred to as methods) described below.

Each transmitter 144 may include any suitable structure for generating signals, such as control signals as described in detail below, for wireless transmission to one or more STAs 112. Each receiver 146 may include any suitable structure for processing signals received wirelessly from one or more STAs 112. Although shown as separate components, at least one transmitter 144 and at least one receiver 146 may be integrated and implemented as a transceiver. Each antenna 148 may include any suitable structure for transmitting and/or receiving wireless signals. Although common antennas 148 are shown in FIG. 2 as being coupled to both the transmitter 144 and the receiver 146, one or more antennas 148 may be coupled to the transmitter 144, and one or more other antennas 148 may be coupled to the receiver 146.

In some embodiments, an AP 102 may include a plurality of transmitters 144 and receivers 146 (or a plurality of transceivers) together with a plurality of antennas 148 for communication in its cell 118.

Each memory 150 may include any suitable volatile and/or non-volatile storage such as RAM, ROM, hard disk, optical disc, SIM card, solid-state memory, memory stick, SD memory card, and/or the like. The memory 150 may be used for storing instructions executable by the processing unit 142 and data used, generated, or collected by the processing unit 142. For example, the memory 150 may store instructions of software, software systems, or software modules that are executable by the processing unit 142 for implementing some or all of the functionalities and/or embodiments of the procedures performed by an AP 102 described herein.

Each input/output component 152 enables interaction with a user or other devices in the communication system 100. Each input/output device 152 may include any suitable structure for providing information to or receiving information from a user and may be, for example, a speaker, a microphone, a keypad, a keyboard, a display, a touch screen, a network communication interface, and/or the like.

Herein, the STAs 112 may be any suitable wireless device that may join the communication system 100 via an AP 102 for wireless operation. In various embodiments, a STA 112 may be a wireless electronic device used by a human or user (such as a smartphone, a cellphone, a personal digital assistant (PDA), a laptop, a desktop computer, a tablet, a smart watch, a consumer electronics device, and/or the like). A STA 112 may alternatively be a wireless sensor, an Internet-of-things (IoT) device, a robot, a shopping cart, a vehicle, a smart TV, a smart appliance, a wireless transmit/receive unit (WTRU), a mobile station, or the like. Depending on the implementation, the STA 112 may be movable autonomously or under the direct or remote control of a human, or may be positioned at a fixed position.

In some embodiments, a STA 112 may be a multimode wireless electronic device capable of operation according to multiple radio access technologies and incorporate multiple transceivers necessary to support such.

In addition, some or all of the STAs 112 include functionality for communicating with different wireless devices and/or wireless networks via different wireless links using different wireless technologies and/or protocols. Instead of wireless communication (or in addition thereto), the STAs 112 may communicate via wired communication channels to other devices or switches (not shown), and to the Internet 106. For example, a plurality of STAs 112 (such as STAs 112 in proximity with each other) may communicate with each other directly via suitable wired or wireless sidelinks.

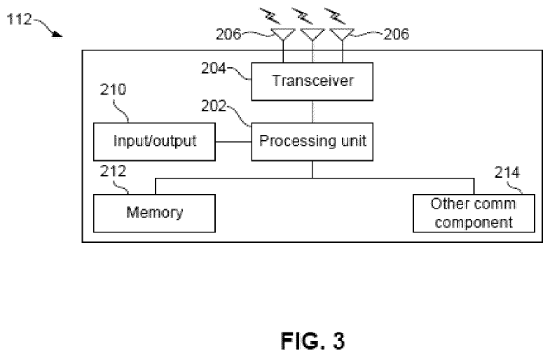

FIG. 3 is a simplified schematic diagram of a STA 112. As shown, the STA 112 includes at least one processing unit 202, at least one transceiver 204, at least one antenna or network interface controller (NIC) 206, one or more input/output components 210, at least one memory 212, and at least one other communication component 214. Each of these components 202 to 214 may be implemented as one or more circuits (such as one or more electronic circuits and/or one or more optical circuits). Alternatively, the ensemble of these components 202 to 214 may be implemented as one or more circuits. In various embodiments, the STA 112 may also include other components as needed or as desired.

The processing unit 202 is configured for performing various processing operations such as signal coding, data processing, power control, input/output processing, or any other functionalities to enable the STA 112 to access and join the communication system 100 and operate therein. The processing unit 202 may also be configured to implement some or all of the functionalities of the STA 112 described in this disclosure. The processing unit 202 may include a central processing unit (CPU), a microprocessor, a microcontroller, a digital signal processor, an accelerator, a graphic processing unit (GPU), a tensor processing unit (TPU), a FPGA, or an ASIC. Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like. In some embodiments, the processing unit 202 may execute computer-executable instructions or code stored in the memory 212 to perform various processes described below.

The at least one transceiver 204 may be configured for modulating data or other content for transmission by the at least one antenna 206 to communicate with an AP 102. The transceiver 204 is also configured for demodulating data or other content received by the at least one antenna 206. Each transceiver 204 may include any suitable structure for generating signals for wireless transmission and/or processing signals received wirelessly. Each antenna 206 may include any suitable structure for transmitting and/or receiving wireless signals. Although shown as a single functional unit, a transceiver 204 may be implemented separately as at least one transmitter and at least one receiver.

The one or more input/output components 210 is configured for interaction with a user or other devices in the communication system 100. Each input/output component 210 may include any suitable structure for providing information to or receiving information from a user and may be, for example, a speaker, a microphone, a keypad, a keyboard, a display, a touch screen, and/or the like.

The at least one memory 212 is configured for storing instructions executable by the processing unit 202 and data used, generated, or collected by the processing unit 202. For example, the memory 212 may store instructions of software, software systems, or software modules that are executable by the processing unit 202 for implementing some or all of the functionalities and/or embodiments of the STA 112 described herein. Each memory 212 may include any suitable volatile and/or non-volatile storage and retrieval components such as RAM, ROM, hard disk, optical disc, SIM card, solid-state memory modules, memory stick, SD memory card, and/or the like.

The at least one other communication component 214 is configured for communicating with other devices such as other STAs 112 via other communication means such as a radio link, a BLUETOOTH® link (BLUETOOTH is a registered trademark of Bluetooth Sig Inc., Kirkland, WA, USA), a wired sidelink, and/or the like. Examples of the wired sidelink may be a USB cable, a network cable, a parallel cable, a serial cable, and/or the like.

In some embodiments, a STA 112 may include a plurality of transceivers 204 and a plurality of antennas 206 for communication with an AP 102.

In the communication between the AP 102 and the STA 112, a transmission from the STA 112 to the AP 102 is usually denoted an uplink (UL) and the wireless channel used therefor is denoted an uplink channel. A transmission from the AP 102 to the STA 112 is usually denoted a downlink (DL) and the wireless channel used therefor is denoted a downlink channel.

In physical layer (PHY), the frequency-time resource of the channel 114 is partitioned into physical layer protocol data units (PPDUs; also called “packets”), and the AP 102 or STA 112 transmits data as PPDUs or packets. Suitable modulation technologies may be used for communication between the AP 102 and the STA 112. For example, in some embodiments, orthogonal frequency-division multiplexing (OFDM) may be used wherein the channel 114 is composed of a plurality orthogonal subcarriers for communication between the AP 102 and the STA 112. Moreover, as there are usually a plurality of STAs 112 in communication with a same AP 102, suitable multiple-access technologies may be used. For example, in some embodiments, orthogonal frequency-division multiple access (OFDMA) may be used for communication between the AP 102 and STAs 112.

Some existing methods for addressing LL traffic rely on stopping and retransmitting the ongoing non-low-latency packet, which introduces inefficiencies, consumes additional resources of the devices and increases packed delivery time. LL services are typically handled through the enhanced distributed channel access (EDCA), where every traffic class is given a fixed contention window (CW) and a different arbitration inter-frame space (AIFS) based on priority, giving a statistical advantage to LL traffic over other traffic classes during contention for channel access.

Such EDCA approach does not guarantee immediate access to the medium, especially in high-traffic scenarios where contention delays can significantly impact LL performance. Furthermore, using the EDCA approach, once a transmission starts and is ingoing, an ongoing PPDU would have to be terminated and retransmitted later to accommodate urgent LL traffic, leading to potential long packet delays or increased jitter. In some cases, LL traffic may arrive at (i.e. non-AP) STAs unexpectedly, for example traffic arrived at a device that is neither the current TXOP holder nor the TXOP responder. It has been realized that currently known procedures are silent as to methods for immediately or substantially immediately prioritizing this urgent LL traffic.

Additionally, when a STA encounters LL traffic, currently there is typically a disruption of the ongoing transmission and retransmission of the entire non-LL packet is performed later. This complete retransmission process wastes the radio resources already used during the initial partial transmission and consumes additional channel time, further reducing overall wireless system efficiency. Such inefficiencies become particularly pronounced in environments with frequent LL events, where repeated complete retransmissions can significantly degrade network throughput and performance.

Embodiments of the present disclosure are directed at equipping devices, such as STAs and APs, in a wireless network with mechanisms that enable such devices to pause an ongoing transmission therebetween, such as an ongoing PPDU or an ongoing TXOP, in response to a triggering event, such as an indication of a LL traffic to be received by an AP, for example from a STA, insufficient resources at one of the devices, network disruptions, in device coexistence scenarios where a STA needs to temporarily disable or pause one of its wireless functionalities (e.g., Wi-Fi® transceiver (TRX) circuitry) to redirect or utilize associated resources (e.g., antennas) for another wireless functionality (e.g., Bluetooth™, Zigbee™, etc.), etc. Embodiments disclosed herein enable deterministic delay for LL packets, contributing to ultra-high, reliable, real-time wireless communication service.

Embodiments of the present disclosure provide example signaling frameworks to improve wireless network communications, such as improving LL support, by leveraging a physical layer (PHY) and media access control (MAC) features for addressing one or more of the challenges presented above.

In embodiments, leveraging PHY features enables a first device, such as a STA, to pause its ongoing uplink (UL) transmission to a second device, to notify the second device that the ongoing transmission is being paused to be resumed later, and to resume the paused ongoing transmission later,, enabling the first device to handle unexpected events, such as the arrival of LL traffic at the first device, the second device, or at another device. of Radio resources already utilized (e.g., allocated, assigned) for the ongoing transmission can be preserved during the pause and continue to be utilized once the ongoing transmission is resumed, thereby improving overall system efficiency and throughput.

In embodiments, MAC features (e.g., frames) are utilized for transmitting and receiving indications, commands, and requests associated with the pausing and resuming of the ongoing transmission. Such utilizing, as disclosed herein by way of example embodiments, provides mechanists for a first device, such as any STA in the wireless network, to notify a second device having an ongoing transmission with a third device, about LL traffic arrival, enabling timely channel access for improved LL traffic handling. Embodiments provide methods and systems for supporting TXOP-level and PPDU-level preemption with limited disruption to ongoing (e.g., non-LL) transmissions.

In embodiments, any non-AP STA can signal its LL traffic needs to the AP by transmitting a transmission pause request frame. Upon determining that the ongoing transmission should be stopped, if the AP is a recipient of an ongoing transmission, then the AP can then transmit a transmission pause command frame to a transmitting device that is transmitting the ongoing transmission to the AP, to facilitate or enforce the pause of the ongoing transmission. Once the LL traffic has been served, the AP can send a transmission resume command frame to the transmitting device to continue its paused ongoing transmission, thereby providing a mechanism that allows preserving of ongoing non-LL packets by pausing and resuming their transmission, thereby contributing to conserving radio resources and improving overall network efficiency.

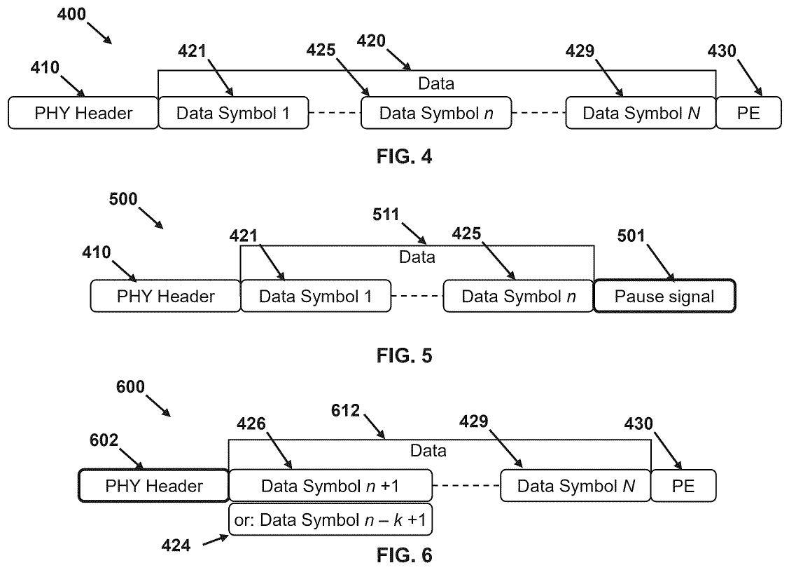

FIG. 4 shows a schematic illustration of a (e.g., PPDU) transmission in an OFDM/OFDMA-based wireless communication system. In a typical Wi-Fi® system, a transmission 400 (e.g., PPDU, packet) begins with a sequence of OFDM/OFDMA symbols carrying or modulated with the PHY Header bits, collectively referred as the PHY Header Signal 410 or the Start Frame Delimiter (SFD) followed by a sequence of OFDM/OFDMA data symbols that include a first data symbol 421, an n^{th} data symbol 425 and a last data symbol N 429 that collectively comprise the data 420 carried by the transmission 400, and may end with an optional Packet Extension (PE) 430.

In embodiments, a first device (i.e., sender of an ongoing transmission, e.g., STA, AP, also referred to herein as a transmitting device) that has an ongoing transmission (e.g., a PPDU, TXOP) from the first device to (e.g., one or more) second device (i.e., also referred to herein as receiving device(s)), transmits a transmission pause indication that is indicative of pausing of the ongoing transmission by the first device to be resumed later by the first device. The transmission of the pause indication signals to the (e.g., each of the) receiving device(s) that the ongoing transmission is temporarily paused to be resumed at a later time.

In embodiments, the transmitting device may transmit the ongoing transmission to one or more receiving devices. Embodiments described refer to a receiving device by way of a non-limiting example and are similarly applicable to cases where more than one receiving device is receiving the ongoing transmission from the transmitting device. In cases where pausing of the ongoing transmission is requested by one of the receiving devices (e.g., one of the receiving devices has insufficient resources to continue receiving the ongoing transmission), then the receiving device can request a pause by sending a pause request frame on another link (cross-link signaling) or piggyback pause request on an acknowledgment feedback (Ack, BA or multi-STA BA) or using one of reserved RUs for pause request indication.

In embodiments, the transmission pause indication may be a pause signal. The pause signal may include a single OFDM/OFDMA symbol carrying a predefined sequence (e.g., Pmatrix, Hadamard, Zadoff-Chu, Golay, etc).

FIG. 5 shows an example of a paused transmission 500 that includes a PHY Header Signal 410 followed by a sequence of OFDM/OFDMA data symbols that include a first portion 511 of the data 420 of FIG. 4. The first portion 511 includes data from a first data symbol 421 to an n^{th} data symbol 425, inclusively. The n^{th} data symbol 425 is followed by the pause signal 501.

The receiving device(s) can be configured to inspect the ongoing transmission to recognize or detect the transmission pause indication, such as the pause signal 501 of FIG. 5, to determine whether the transmission pause indication is valid (e.g., predefined, predetermined). If the receiving device determines that the detected transmission pause indication is valid, the receiving device may store (e.g., buffer) in its memory (e.g., physical memory, virtual memory, etc.) the received first portion of the ongoing transmission to be later combined with a subsequent (e.g., one or more, as the case may be if additional pausing of the ongoing transmission occurs) portion of the ongoing transmission to obtain the complete transmission. The duration or storing the first portion (or any number of portions from a first portion to an m^{th} portion if the ongoing transmission is paused a corresponding number of times) can be a predefined value, measured for example in ms. The duration may be based or quantity or size of portions of the ongoing transmission received. The duration may be based on a predefined setting such as until a subsequent transmission (e.g., subsequent to the ongoing transmission, or a subsequent portion of the ongoing transmission, in which case the stored portion(s) may be combined with the subsequent portion as it is being received) being received.

In embodiments, to resume the ongoing transmission (e.g., a PPDU, TXOP) that has been paused by the first device (i.e., sender of the ongoing transmission, e.g., STA, AP), the first device transmits to the second device (i.e., the receiver of the ongoing transmission) a transmission resume indication that is indicative of resuming of the ongoing transmission that has been earlier paused by the first device. The transmission resume indication signals or indicates to the second device that the ongoing transmission is being resumed and that the transmission that immediately follows or is associated with the transmission resume indication is a continuation of the ongoing transmission that has been paused earlier (e.g., a subsequent portion of a previously transmission portion of a same PPDU or packet, a continuation of a same TXOP that has been passed earlier).

FIG. 6 shows an example of a resumed transmission 600 that includes a resume transmission indication 602 (e.g., a resume signal) followed by a sequence of OFDM/OFDMA data symbols that include a second portion 612 of the ongoing transmission data 420 if FIG. 4. The second portion 612 includes data from the (n+1) data symbol 426 to the last data symbol N 429, inclusively. The last data symbol 429 is optionally followed by the PE 430.

Notably, in embodiments, the ongoing transmission may be paused more than once, in each case a respective transmission pause indication and a respective transmission resume indication may be transmitted by the transmitting device to the receiving device.

In an embodiment, the second portion 612 of the data 420 may include a predetermined portion k, also referred to herein as a resume offset, of the first portion 511 of FIG. 5 that immediately precedes the second portion 612 and, more specifically, precedes the (n+1) data symbol 426. In such case, the transmission resume indication 602, or a PHY header inclusive thereof, is followed by (n−k+1) data symbol 424 which is followed by subsequent data symbols through to the last data symbol N 429 and optionally the PE 430. In other words, the second portion of the ongoing transmission includes a predetermined number k of data symbols that have already been transmitted in the first portion of the ongoing transmission. Retransmitting a predetermined number of symbols of the first portion, although not the complete first portion, may aid or facilitate the receiving device in combining the first portion with the second portion, for example to improve the accuracy of such combining, improve the synchronization of the received portions of the ongoing transmission, and improve the overall transmission accuracy. The predetermined portion of the first portion of the ongoing transmission to be retransmitted in the second portion may include a predetermined number of data symbols, a fixed number of data symbols, or a previously indicated (e.g., as indicated in a transmission resume command) number of data symbols.

In embodiments, the receiving device may be configured to utilize the predetermined portion k in combining the second portion, that includes or retransmits the predetermined portion, with the previously received first portion.

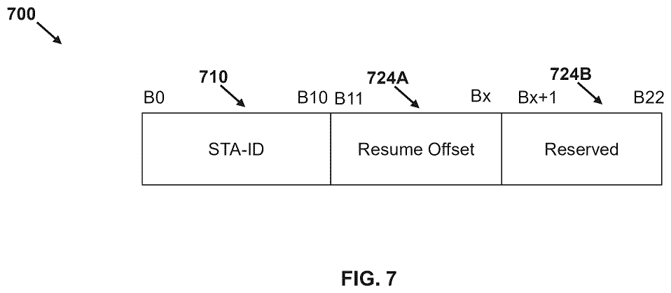

In an embodiment, if the receiving device transmits a transmission pause command to the transmitting device to pause its ongoing transmission to the receiving device, the receiving device may include an indication of the predetermined portion to the used by the transmitting device when the ongoing transmission is resumed. In this case, such indication may be included in the transmission pause command. The transmitting device may retransmit the predetermined portion according to such indication of the predetermined portion received from the receiving device. The predetermined portion to be retransmitted may be indicated, for example, by reusing 1 to 6 bits of the reserved bits (e.g., B20-B25) in the U-SIG-1, as described elsewhere herein with reference to FIG. 9, for such indication. In another example, an additional special 23 bit user info field may be included in the PHY preamble, with a STA AID greater than 2007. Such 23 bit field can have a format similar to the format of regular user info fields, for example, by starting with the STA AID followed by the resume offset, as described elsewhere herein with reference to FIG. 7. In another example, the resume offset may be predefined in a beacon frame or as a constant value in a future Wi-Fi® 8 (i.e., UHR) amendment.

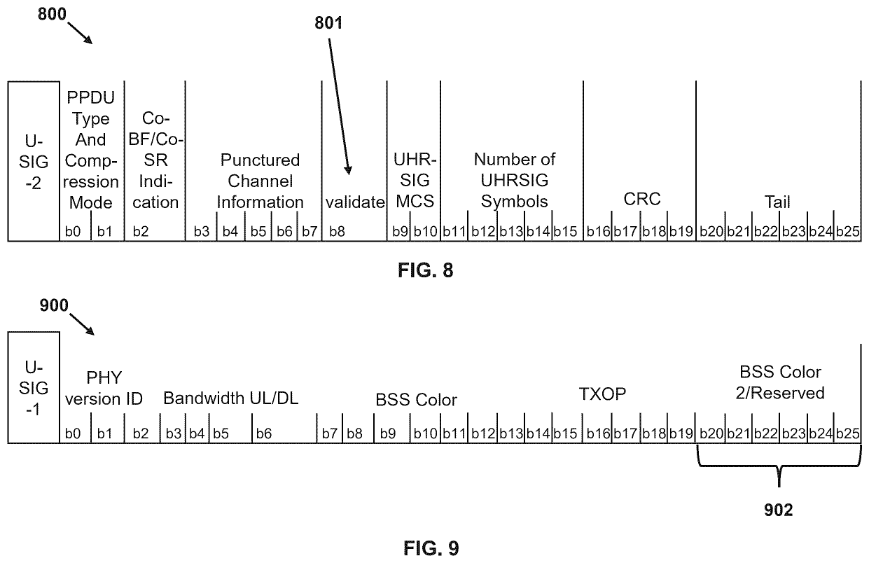

In an embodiment, the transmitting device may indicate the predetermined portion to be retransmitted in the subsequent portion of the ongoing transmission following pausing thereof, using one or more bits selected from bits B20 through B25 of the U-SIG-1 field shown in FIG. 8, as long as these one or more bits are available and not utilized otherwise, such as in association with Co-SR) and/or Co-BF. Notably, in IEEE 802.11bn (UHR Wi-Fi® 8) standard, three types of PPDUs are supported, namely, Multi-user PPDU (MU-PPDU), Trigger-based PPDU (TB-PPDU), and Enhanced Long Range PPDU (ELR-PPDU), in all of which these bits B20 through B25 are reserved, with an exception of cases where coordinated spatial reuse (Co-SR) and/or coordinated beamforming (Co-BF) are used.

In an embedment, with reference to FIG. 7, an additional special User info field 700, for example having a length of 23 bits, may be included in the PHY preamble of the second portion of the ongoing transmission that is being resumed, with a STA AID 710 greater than 2007. This field 700 may have a design similar to the design of a regular user info field by starting first with the STA AID 710, followed by the predetermined portion indication 720 and, optionally, any remaining bits 730 as reserved bits.

In an embodiment, the predetermined portion may be a predefined constant or fixed value, as defined in a Wi-Fi 8® (UHR) amendment or a later amendment.

The resumed transmission 600 may be a subsequent portion of an ongoing PPDU, the preceding portion of which has already been transmitted.

In embodiments, the resumed transmission may include the transmission resume indication in a modified SIG field to enable the receiving device(s) to correctly interpret the transmission as a resumed transmission (e.g., second portion, subsequent portion) of the ongoing transmission, some of which (e.g., first portion, preceding portion) has already been transmitted and received, a single bit may be assigned or allocated in a U-SIG of the resumed transmission.

In an embodiment, the validate bit B8 801 in U-SIG-2 field 800 shown in FIG. 8 may be used for the transmission resume indication. Such bit B8 may be defined to have a corresponding value of 0, for example, indicative to the receiving device that the transmission is a subsequent portion of a previously paused ongoing transmission.

In an embodiment, a bit may be selected from the bits B20 through B25 902 in the U-SIG-1 field 900 shown in FIG. 9 for the transmission resume indication, as long as at least one or more of these bits 902 are available and not utilized otherwise, such as in association with Co-SR and/or Co-BF in UHR MU-PPDU transmission types (it is reserved in other UHR defined types, as noted elsewhere herein).

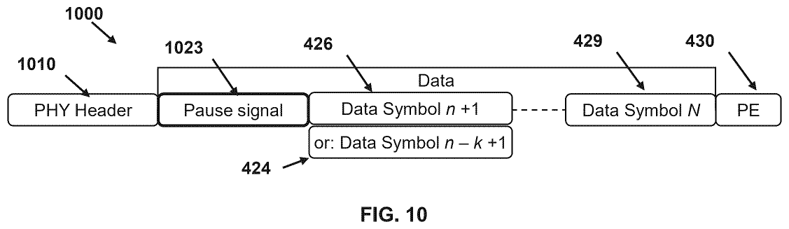

In an embodiment, the transmission resume indication may include the same signal as that of the preceding transmission pause indication that indicated the pause of the ongoing transmission. With reference to FIG. 10, instead of utilizing the U-SIG field, as described above with reference to FIGS. 8 and 9, to include a bit for the transmission resume indication, the transmission resume indication may be a resume signal 1023 that is included as the first symbol following the PHY header 1010 and the first symbol preceding the data symbol (n+1) 426 or (n−k+1) 424 of the resumed transmission 1000 (e.g., resume signal 1023 is or begins with the pause signal 501 of FIG. 5), allowing the receiving device to recognize the transmission as a continuation of the previously paused ongoing transmission.

In embodiments, pausing and resuming of the ongoing transmission by the transmitting device may be done according to a triggering event. The triggering event may necessitate or require the transmitting device to pause the ongoing transmission. The triggering event may be an unexpected or an anticipated event, such as an arrival of a priority (e.g., LL) transmission or an indication of an incoming priority transmission to be received by the transmitting device or by the receiving device. The triggering event may be an indication of computing resources at the receiving device or a transmitting device being below a predetermined threshold (e.g., low battery power, low CPU, low memory, unstable wireless connection, resource being redirected elsewhere, etc.) and, therefore, being (or likely being) insufficient or unavailable for a successful completion of the ongoing transmission (e.g., may be low power, may be poor connection, may be due to an existence event that necessitates the utilization of resources of the device elsewhere). The transmitting device may itself determine or detect a triggering event. The transmitting device may receive an indication of the triggering event (e.g., a transmission pause command) from the receiving device or another device (e.g., a device having a LL transmission for the transmitting device(s) and/or the receiving device(s), for example in cases where the LL transmission multi-case broadcast LL transmission). The triggering event may be a combination of one or more triggering events.

In embodiments, the transmitting device may resume the ongoing transmission, that has been paused in response to a triggering event, after or in response to determining that the triggering event (or each triggering event of a combination of triggering events) is complete. The transmitting device may itself determine or detect that the triggering event is complete (e.g., the transmitting device has finished receiving a priority transmission, the computing resources at the transmitting device or receiving device are sufficient for continuing the paused ongoing transmission, a (e.g., in-device) device coexistence event has been completed). The transmitting device may receive an indication of the completion of the triggering event (e.g., a transmission resume command) from the receiving device (e.g., the receiving device has finished receiving a priority transmission, the computing resources at the receiving device are sufficient for continuing the paused ongoing transmission) or another device (e.g., a third device has finished transmitting a LL transmission to the receiving device).

In embodiments, if a new triggering event occurs while the ongoing transmission is being paused in response to a preceding triggering event, the ongoing transmission may remain paused until both the preceding and the new triggering events are complete.

In embodiments, the devices of the wireless network may be configured to support an additional device (e.g., non-AP STA) to inform its associated AP of a triggering event, such as a priority transmission (e.g., LL transmission) to be transmitted by the additional device to the associated AP. The additional device may transmit a transmission pause request to the associated AP, for example via cross-link signaling or a dedicated resource unit (RU) reserved for indications such as the transmission pause request. Notably, in cases where a dedicated RU is reserved, the additional device that has a LL transmission may utilize a channel access method, e.g., Uplink OFDMA Random Access (UORA), Carrier Sense Multiple Access with Collision Avoidance (CSMA/CA) or an Additive Links On-line Hawaii Area (ALOHA) variant. The associated AP may be the transmitting device, in which case it may proceed to pause the ongoing transmission by transmitting the transmission pause indication to the receiving device. The associated AP may be the receiving device, in which case it may transmit a transmission pause command to the transmitting device, for example using either cross-link signaling or a dedicated RU, thereby instructing the transmitting device to pause the ongoing transmission to the receiving device. When the triggering event has completed (e.g., the priority traffic has been successfully received at the associated AP), then, if the associated AP is the transmitting device, it may proceed by resuming the ongoing transmission by transmitting the subsequent portion that includes the transmission resume indication. When the triggering event has completed and the associated AP is the receiving device, then it may transmit a transmission resume command frame to the transmitting device, for example using either cross-link signaling or a dedicated RU, thereby instructing the transmitting device to resume the ongoing transmission to the receiving device(s).

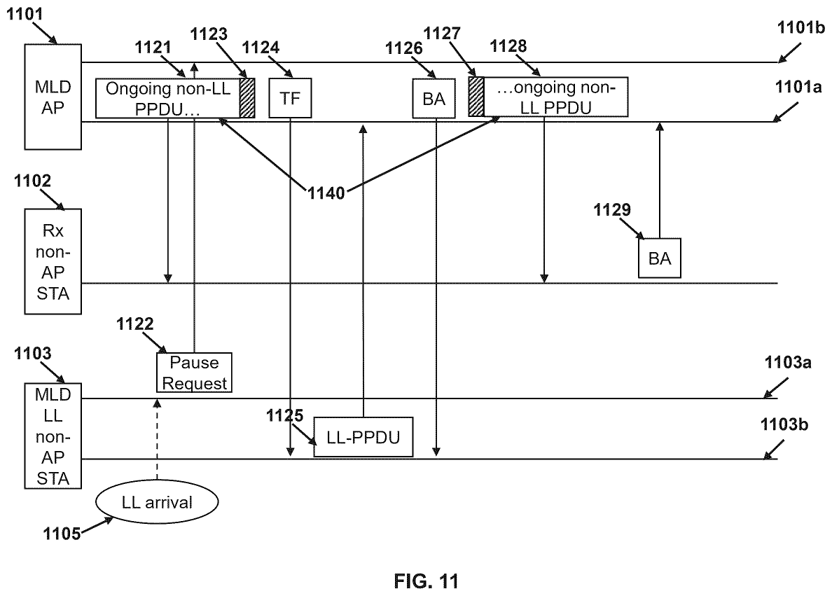

In an example embodiment shown in FIG. 11, the transmitting device 1101 is a multi-link, or full-duplex capable, AP having each link assigned a different frequency channel or band, and has an ongoing transmission 1140, such as a non-LL PPDU, using a first transmitting device channel 1101a, with the receiving device 1102 that is a non-AP STA. An additional device 1103 is a multi-link non-AP STA. While the transmitting device 1101 is transmitting, using the first transmitting device channel 1101a, a first portion 1121 of the ongoing transmission 1140 to the receiving device 1102, the additional device 1103 receives a LL transmission 1105 for the transmitting device 1101 on a first additional device channel 1103a. The additional device 1103 transmits, using the first additional device channel 1101a, a transmission pause request 1122 to the transmitting device 1101. The transmitting device 1101 receives the transmission pause request 1122 at a second transmitting device channel 1101b, pauses the ongoing transmission 1140, and transmits a transmission pause indication 1123 to the receiving device 1102 using the first transmitting device channel 1101a. The receiving device 1102 receives the transmission pause indication 1123 and stores the first portion 1121 in its memory (not shown). The transmitting device 1101 transmits, using the first transmitting device channel 1101a, a trigger frame (TF) 1124 to the additional device 1103 to begin receiving the LL transmission 1105. The additional device 1103 receives the TF 1124 at the second additional device channel 1103b, forms a LL-PPDU 1125 and transmits it to the transmitting device 1101 using the second additional device channel 1103b. Once the transmitting device 1101 successfully receives the LL-PPDU 1125 using the first transmitting device channel 1101a, it transmits, using the same channel, a block acknowledgement (BA) or an Acknowledgment (ACK)) frame 1126 to the additional device 1103, and resumes the ongoing transmission 1140, using the first transmitting device channel 1101a, by transmitting the transmission resume indication 1127 followed by the second portion 1128 of the ongoing transmission 1140, to the receiving device. The receiving device(s) transmits a BA, which may be an ACK or a multi-STA BA, Frame 1129 to the transmitting device to acknowledge that the ongoing transmission 1140 has been successfully received.

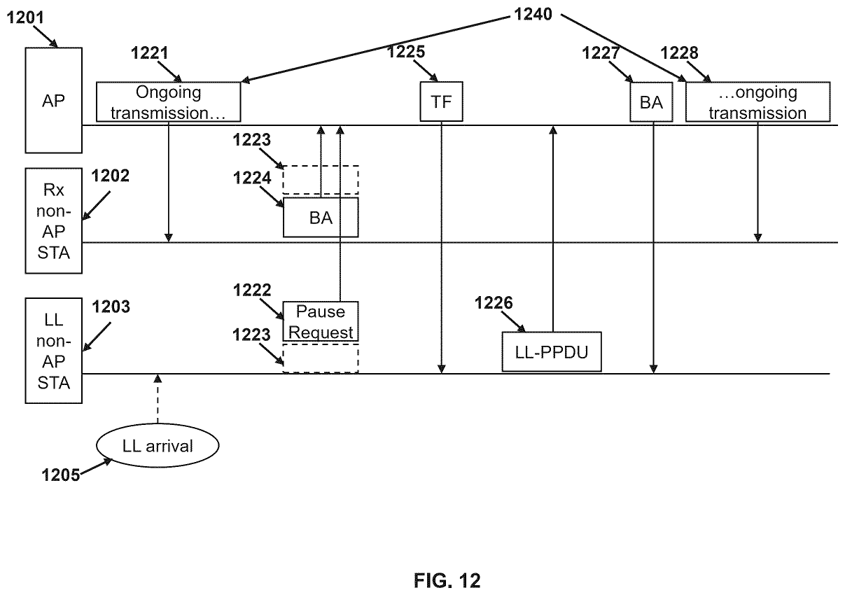

In an example embodiment shown in FIG. 12, the transmitting device 1201 is an AP and has an ongoing TXOP transmission 1240 with the receiving device 1202 that is a non-AP STA. An additional device 1203 is a non-AP STA. While the transmitting device 1201 is transmitting a first portion 1221, such as a first PPDU, of the ongoing TXOP transmission 1240 to the receiving device 1202, the additional device 1203 receives a LL transmission 1205 for the transmitting device 1201. The additional device 1203 uses a dedicated RU 1223, reserved for the duration of the first portion 1221, to include the transmission pause request 1222 for the transmitting device 1201. When the receiving device 1102 has successfully received the first portion 1221, it transmits a BA 1224 that includes using the dedicated RU 1223 that includes the transmission pause request 1222, to the transmitting device 1201. The transmitting device 1201 receives the transmission pause request 1222, pauses the ongoing TXOP transmission 1240, and may optionally transmit a transmission pause indication to the receiving device 1202 (not shown). The transmitting device 1201 transmits a TF 1225 to the additional device 1203 to begin receiving the LL transmission 1205. The additional device 1203 receives the TF 1225, forms a LL-PPDU 1226 and transmits it to the transmitting device 1201. Once the transmitting device 1201 successfully receives the LL-PPDU 1226, it transmits a BA 1227 to the additional device 1203, and resumes the ongoing transmission 1240, optionally by transmitting a transmission resume indication (not shown), or directly resuming the ongoing transmission by sending a regular Trigger Frame (TF). followed by the subsequent portion 1228, such as a second PPDU, of the ongoing TXOP transmission 1240 to the receiving device 1202.

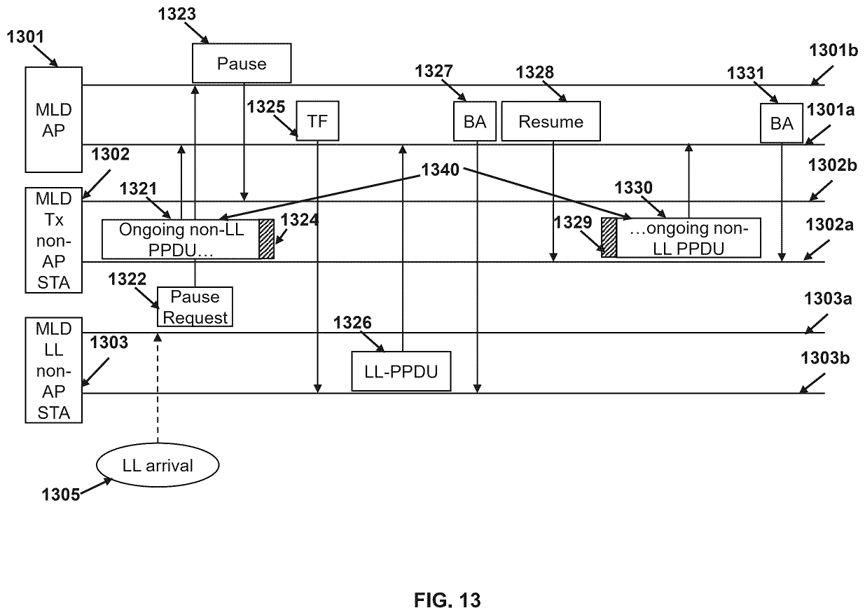

In an example embodiment shown in FIG. 13, the receiving device 1301 is a multi-link AP and is receiving an ongoing transmission 1340, such as a non-LL PPDU, using a first receiving device channel 1301a, from the transmitting device 1302 that is a multi-link non-AP STA. An additional device 1303 is another multi-link non-AP STA. While the transmitting device 1302 is transmitting a first portion 1321 of the ongoing transmission 1340 to the receiving device 1301 using the first transmitting device channel 1302a, the additional device 1303 receives a LL transmission 1305 for the receiving device 1301 on a first additional device channel 1303a. The additional device 1303 transmits, using the first additional device channel 1301a, a transmission pause request 1322 to the receiving device 1301. The receiving device 1301 receives the transmission pause request 1322 at a second receiving device channel 1301b and transmits a transmission pause command 1323 to the transmitting device 1302 using the second receiving device channel 1301b. The transmitting device 1302 receives transmission pause command 1323 using the second receiving device channel 1302b, pauses the ongoing transmission 1340, and transmits the transmission pause indication 1324 to the receiving device 1301. The receiving device 1301 receives the transmission pause indication 1324 and stores the first portion 1321 in its memory (not shown). The receiving device 1301 transmits, using the first receiving device channel 1301a, a TF 1325 to the additional device 1303 to begin receiving the LL transmission 1305. The additional device 1303 receives the TF 1325 at the second additional device channel 1303b, forms a LL-PPDU 1326 and transmits it to the receiving device 1301 using the second additional device channel 1303b. Once the receiving device 1301 successfully receives the LL-PPDU 1326 using the first receiving device channel 1301a, it transmits, using the same channel, a BA 1327 to the additional device 1303, and transmits a transmission resume command 1328 to the transmitting device 1302 using the first transmitting device channel 101a. The transmitting device 1302 resumes the ongoing transmission 1340, using the first transmitting device channel 1302a, by transmitting the transmission resume indication 1329 followed by the second portion 1330 of the ongoing transmission 1340 to the receiving device 1301. The receiving device 1301 transmits a BA 1331 to the transmitting device 1302 to acknowledge that the ongoing transmission 1340 has been successfully received.

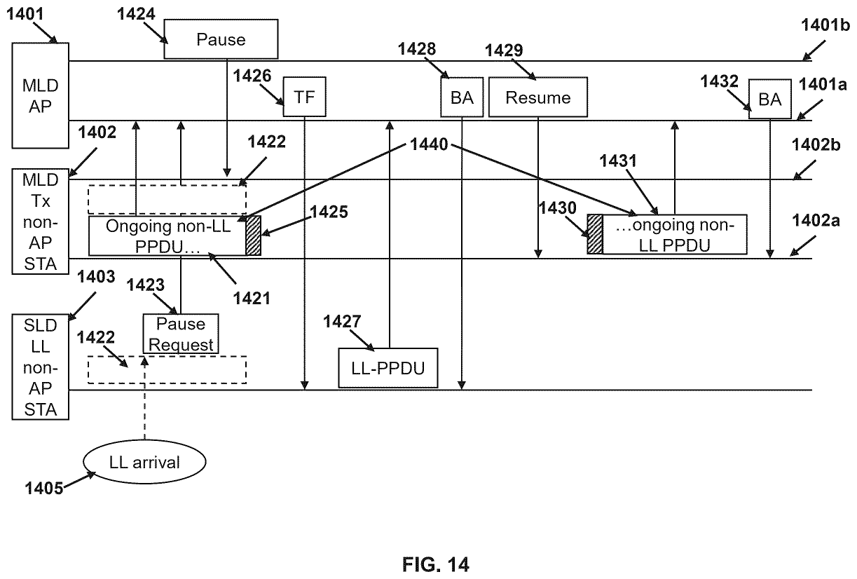

In an example embodiment shown in FIG. 14, the receiving device 1401 is a multi-link AP and is receiving an ongoing transmission 1440, such as a non-LL PPDU, using a first receiving device channel 1401a, from the transmitting device 1402 that is a multi-link non-AP STA. An additional device 1403 is a non-AP STA. While the transmitting device 1402 is transmitting a first portion 1421 of the ongoing transmission 1440 to the receiving device 1401 using the first transmitting device channel 1402a, the additional device 1403 receives a LL transmission 1405 for the receiving device 1401. The additional device 1403, uses a dedicated RU 1422 reserved for the duration of the ongoing transmission 1440, to transmit a transmission pause request 1423 to the receiving device 1401. The receiving device 1401 receives the transmission pause request 1423 at the first receiving device channel 1401a and transmits a transmission pause command 1424 to the transmitting device 1402 using the second receiving device channel 1401b. The transmitting device 1402 receives the transmission pause command 1424 using the second transmitting device channel 1402b, pauses the ongoing transmission 1440, and transmits the transmission pause indication 1425 to the receiving device 1401. The receiving device 1401 receives the transmission pause indication 1425 and stores the first portion 1421 in its memory (not shown). The receiving device 1401 transmits, using the first receiving device channel 1401a, a TF 1426 to the additional device 1403 to begin receiving the LL transmission 1405. The additional device 1403 receives the TF 1426, forms a LL-PPDU 1427 and transmits it to the receiving device 1401. Once the receiving device 1401 successfully receives the LL-PPDU 1427 using the first receiving device channel 1401a, it transmits, using the same channel, a BA 1428 (which may be an ACK) to the additional device 1403, and transmits a transmission resume command 1429 to the transmitting device 1402 using the first transmitting device channel 1401a. The transmitting device 1402 received the transmission resume command 1429, and resumes the ongoing transmission 1440, using the first transmitting device channel 1402a, by transmitting the transmission resume indication 1430 followed by the second portion 1431 of the ongoing transmission 1440 to the receiving device 1401. The receiving device(s) 1401 transmits a BA, which may be an ACK or a multi-STA BA, frame 1432 to the transmitting device 1402 to acknowledge that the ongoing transmission 1440 has been successfully received.

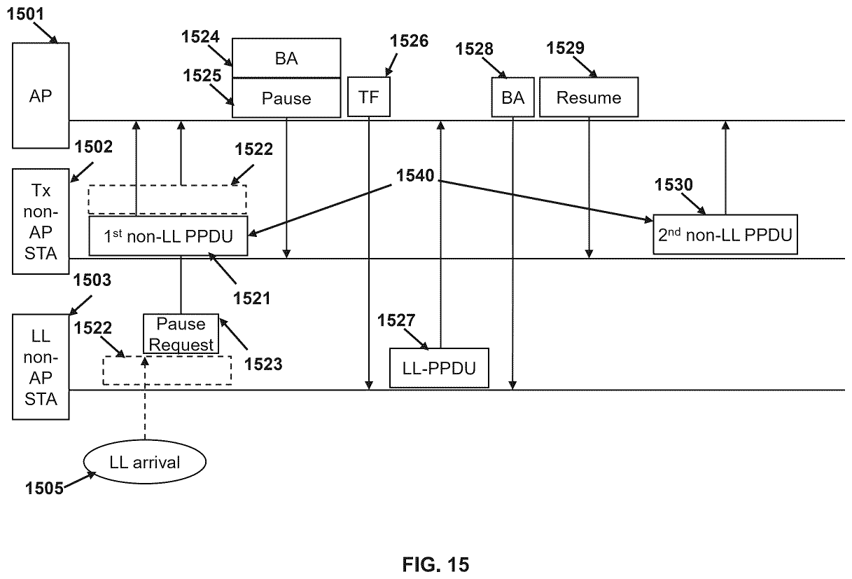

In an example embodiment shown in FIG. 15, the receiving device 1501 is an AP and is receiving an ongoing transmission 1540, such as a first non-LL PPDU 1522 of a TXOP 1540, from the transmitting device 1502. An additional device 1503 is a non-AP STA. While the transmitting device 1502 is transmitting a first portion 1521 of the ongoing transmission 1540 to the receiving device 1501, the additional device 1503 receives a LL transmission 1505 for the receiving device 1501. The additional device 1503 uses a dedicated RU 1522, that is reserved for the duration of the first portion 1521, to transmit a transmission pause request 1523 to the receiving device 1501. The receiving device 1501 receives the transmission pause request 1523 and transmits a transmission pause command 1525 with the BA 1524 to the transmitting device 1502. The transmitting device 1502 receives transmission pause command 1525, pauses the ongoing transmission 1540, and may optionally transmit a transmission pause indication (not shown), for example to maintain TXOP fairness (e.g., the time a STA has to send its PPDU can still be used by that STA; or the AP may not indicate the pause to a STA, which means that the pausing the ongoing transmission may include some time of the TXOP duration obtained by the non-AP STA being unutilized)to the receiving device 1501. The receiving device 1501 transmits a trigger frame 1526 to the additional device 1503 to begin receiving the LL transmission 1505. The additional device 1503 receives the TF 1526, forms a LL-PPDU 1527 and transmits it to the receiving device 1501. Once the receiving device 1501 successfully receives the LL-PPDU 1527, it transmits a BA 1528 to the additional device 1503, and transmits a transmission resume command 1529 to the transmitting device 1502. The transmitting device 1502 resumes the ongoing transmission 1540, optionally (e.g., per AP setting, as predetermined by the AP) by transmitting the transmission resume indication (not shown), and by transmitting the second portion 1530, such as second non-LL PPDU, of the ongoing transmission or TXOP 1540 to the receiving device 1501.

In embodiments, the transmission pause request, which may be a corresponding frame, serves as a notification mechanism for the additional device to notify another device, such as an AP, of a triggering event, such as LL traffic arrival at the additional device for the AP. The transmission pause request may be indicated as a single bit indicating the triggering event, such as the presence of LL traffic.

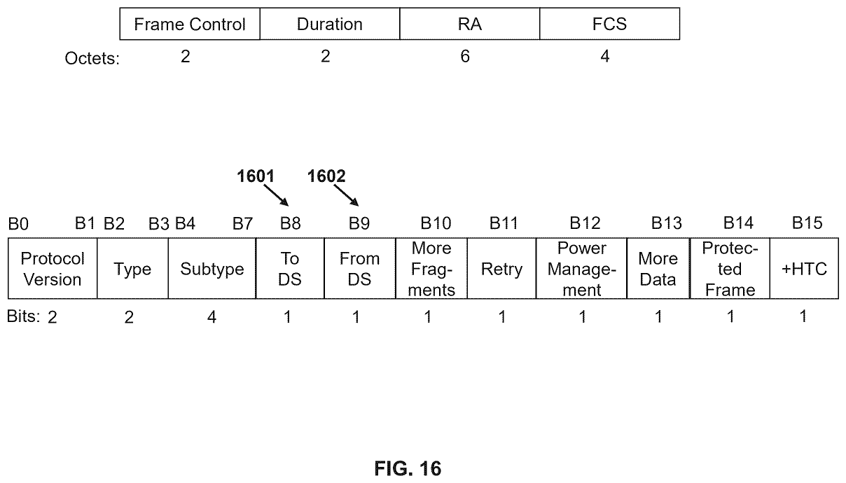

In an example embodiment, a Clear to Send (CTS)-to-Self frame may be utilized to indicate the transmission pause request by modifying two of reserved bits To DS bit B8 1601 and From DS bit B9 1602 which are typically both set to zero for control frames in the current IEEE standards, shown for reference in FIG. 16. One of these bits may be set to 1 to represent the transmission pause request. Notably, other reserved bits in a CTS control frame in the Frame control field that may be similarly utilized include More Frag subfield bit(s), Retry subfield bit(s), i.e., bits B8-B11.

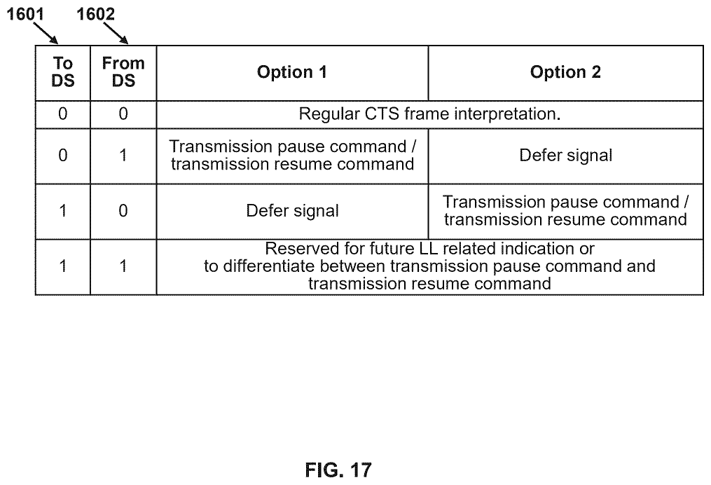

In some embodiments, the transmission pause command may be combined with additional signaling for other (e.g., LL) channel access methods, such as Prioritized Enhanced Distributed Channel Access (P-EDCA) and High Importance EDCA (HIP-EDCA). FIG. 17 shows a table that includes some examples of the possible assignments for the To DS bit 1601 and From DS bit 1602 to indicate one of a transmission pause command and a transmission resume command, or a defer signal (DS), e.g., DS-CTS Frame, which is a CTS Frame with the Address 1 field set to a special value such as the broadcast MAC address. Notably, optionally a same bit can be used as a LL indication and as a defer signal DS-CTS frame depending on the context.

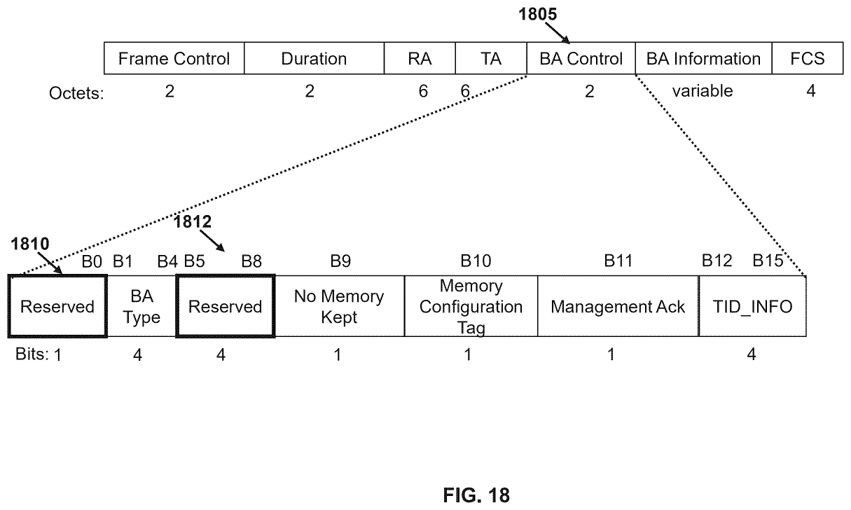

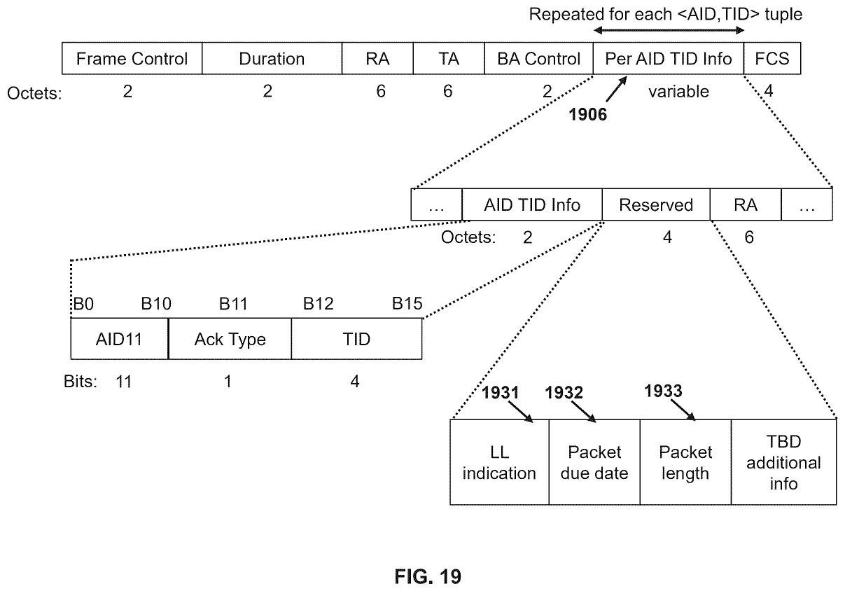

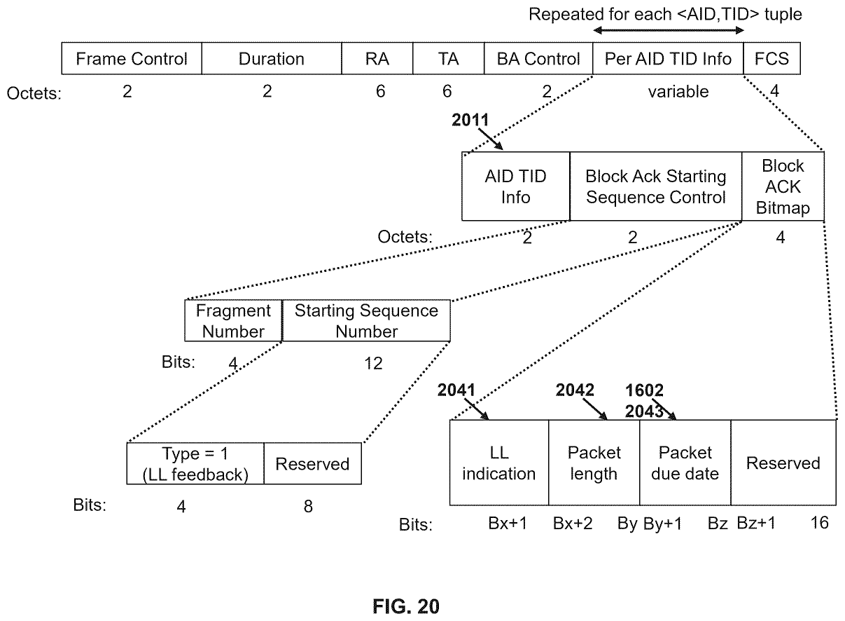

In an example embodiment, a transmission pause request can be embedded within a Block ACK (BA) Control frame. For example, with reference to FIG. 18, one or more of the reserved bits b0 1810 and b5-b8 1812 in the BA Common field 1805 may be repurposed to represent the transmission pause request. In another example, with reference to FIG. 19, the transmission pause request may be included in the Per AID TID info field 1906 configured to include an AID field set to the special AID field, i.e., a value greater than 2007. In this case, the low latency indication 1931 as well as additional details (e.g., packet due date 1932, packet length 1933) may be included. In another example, with reference to FIG. 20, the transmission pause request can be embedded within a BA frame with an alternative feedback information field. In this configuration, the AID field is assigned to the intended non-AP or AP STA AID receiver, while the ACK Type and TID fields are set to 0 and 13, respectively. Following the AID TID info field 2011, the LL information, such as one or more of the LL indication 2041, packet length 2042 and packet due date 2043, may be sent to the AP as shown in FIG. 20. Notably, the sequence and bit-length for representing this information is adjustable and may be suitably selected.

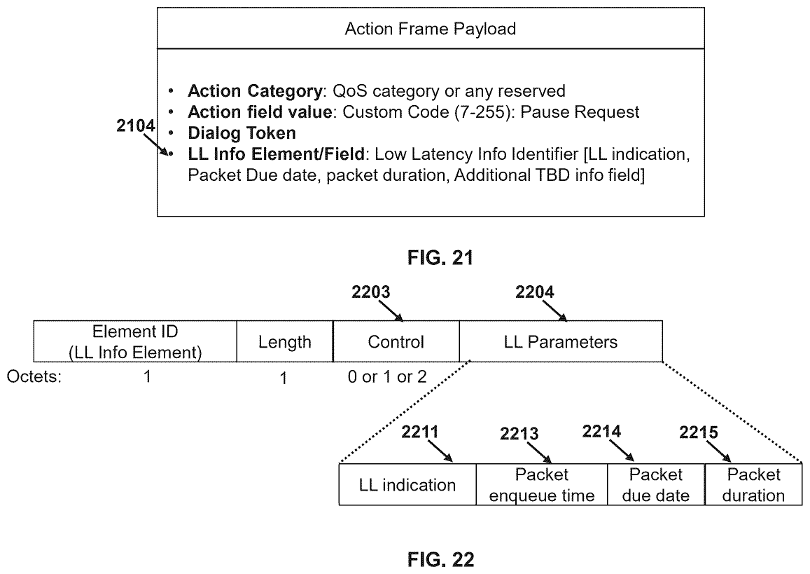

In an example embodiment, the transmission pause request can be implemented as a quality of service (QoS) Action Frame, enabling flexible inclusion of additional one or more signaling fields as shown in FIG. 21. An example definition of the LL info element 2104 is shown in FIG. 22, in which the transmission pause request could be distinguished, in the Control field 2203, from the transmission pause command and transmission resume command by introducing a 2-bit type field. Additionally, the LL parameters field 2204 may contain one or more of the following: a LL indication 2211, packet enqueue time 2213, packet due date 2214, and packet duration 2215.

In an example embodiment, a dedicated transmission pause request frame can be defined that includes a LL indication bit followed by one or more optional fields for one or more of: packet due date, packet duration, and future extensibility.

In embodiments, the transmission pause command (e.g., as a corresponding frame) may be a copy of the transmission pause request forwarded by the receiving device to the transmitting device to pause its ongoing transmission, for example to enable to receiving device to receive a priority transmission. The transmission pause command informs the transmitting device, which is the TXOP holder for the ongoing transmission, to pause its ongoing transmission and can be distinguished. The transmission pause command may be distinguished from a transmission pause request, for example based on the Transmitter Address (TA), where the receiving device, such as the AP, is indicated as the sender while utilizing the same format as the transmission pause request or its corresponding frame. In another example, the transmission pause command may be distinguished from a transmission pause request based on a reserved bit combination within the transmission pause request frame, such as by assigning a different value in one of To/From DS in CTS field, modified BA Control field, and multi-STA BA. In another example, the transmission pause command may be distinguished from a transmission pause request by utilizing a unique Action Type identifier in the Action Frame format. Alternatively, a new frame format may be used for transmission pause command that is different from the frame format for the transmission pause request. Such new frame format may, for example, be similar to a dedicated transmission pause request frame, or may be a modified frame format can be defined to include a LL indication bit followed by optional fields for one or more of packet due date, duration, and future extensibility.

In embodiments, if the triggering event, such as LL traffic, originates at the AP itself when the AP is the receiving device for the ongoing transmission, the AP can directly transmit the transmission pause command to the receiving device that is the TXOP holder without a preceding transmission pause request.

In embodiments, the transmitting device that is the TXOP holder (non-AP STA) for the ongoing transmission may receive the transmission pause command and can indicate its acceptance or acknowledgement, for example implicitly by pausing the ongoing transmission without providing any corresponding indication to the receiving device that is the AP. In such case, the AP may determine the pause if no transmission, e.g., UL PPDU, is received within a predefined duration, such as a duration greater than the regular short interframe space (SIFS), e.g., point coordination function interframe space (PIFS), duration. Notably during un-paused ongoing transmissions, the UL PPDU typically follows a preceding UL PPDU with an interoperation separation duration of SIFS.

In another example, the transmitting device may indicate its acceptance or acknowledgement to pause the ongoing transmission by transmitting a QoS Null/Data frame that includes a Central Authentication Service (CAS) Control field (RDG/more PPDU=0), signaling its (temporary) TXOP release, pause and/or the transmission pause indication in its PHY header.

In another example, the receiving device (the AP) can infer the acceptance or acknowledgement to pause the ongoing transmission by the transmitting device if the ongoing UL transmission was triggered by the AP, in which case the AP has information about the ongoing UL PPDU duration and can infer the pause or wait for a natural termination.

In embodiments, the transmission pause command may be always accepted or optionally accepted by the TXOP holder (e.g., non-AP STA) based on to-be-determined (TBD) rules. For example, the TXOP holder STA device may be configured to accept every n-th transmission pause command with n≥1.

In embodiments, a transmission resume command may be implemented as a MAC frame that returns or facilitates the resumption of the TXOP back to the original TXOP holder device. The transmission resume command frame may include a bit to indicate to the TXOP holder to resume its previous transmission.

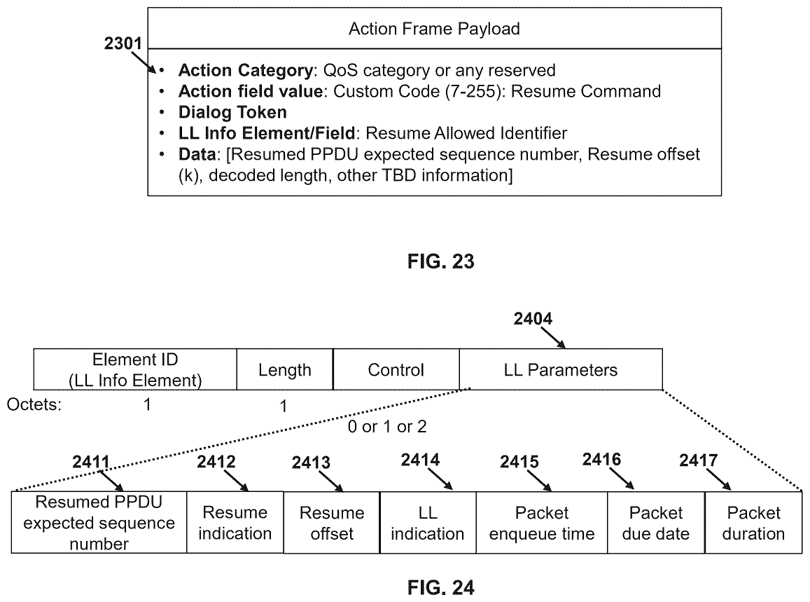

In an example embodiment, the transmission resume command may be implemented as a Management Action Frame that includes an example action category 2301, such as QoS, as shown in FIG. 23. As shown in FIG. 24, the transmission resume command may include a resumption indication as well as any of the following additional information elements: Resumed PPDU expected sequence number 2411, Resume offset 2413, Resume indication 2412, LL indication 2414, packet enqueue time 2416, packet due date 2416, and packet duration 2417, in the LL parameters field 2404. Notably, the transmission resume command may be differentiated from the transmission pause request and the transmission pause command, for example, by including a 2 or more bit type field in the control field.

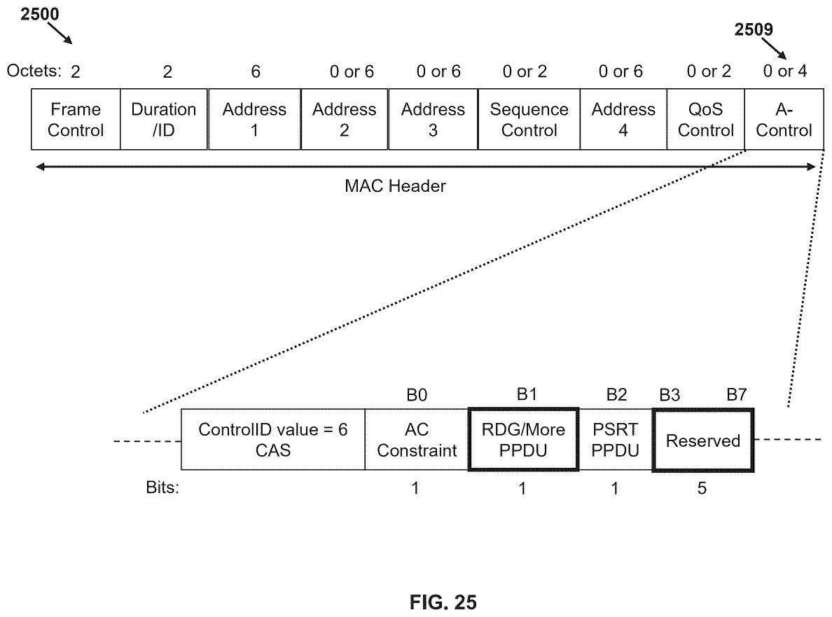

In another example embodiment, the transmission resume command may be embedded in a QoS Null Frame using a Command and Status (CAS) Control field (RDG/more PPDU=1) which by default indicates a TXOP assignment back to the original TXOP holder non-AP STA (the transmitting device in this case). As shown in FIG. 25, a dedicated flag within CAS field 2500 may be included to indicate to the triggered transmitting device STA to resume its paused ongoing transmission before proceeding with a new transmission Notably, the CAS control field may be included within the A-control field 2509 with control ID value of 6.

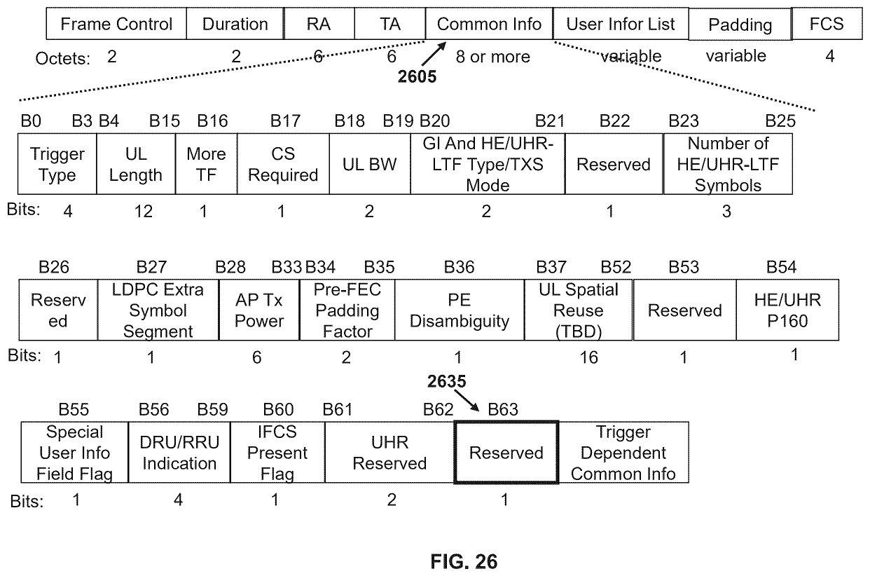

In another example embodiment, the transmission resume command may be included in a trigger frame (e.g., Multi-user Request-to-Send (MU-RTS)). For example, as shown in FIG. 26, a reserved bit B63 2635 in the Common Trigger Header 2605 may be utilized to indicate that the STA is to resume its paused ongoing transmission before initiating a new transmission.

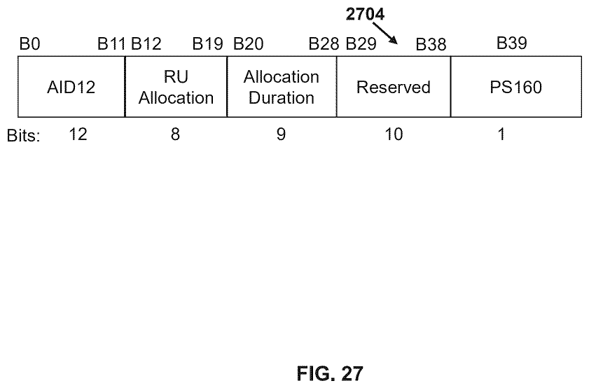

In another example embodiment, as shown in FIG. 27, the transmission resume command may be included in a MU-RTS trigger frame, any one or more of the reserved bits B29-B38 2704 can be selected (e.g., predetermined, preconfigured) for indicating one or more of the following: the transmission resume command, the resume offset k, and the resumed PPDU expected sequence number.

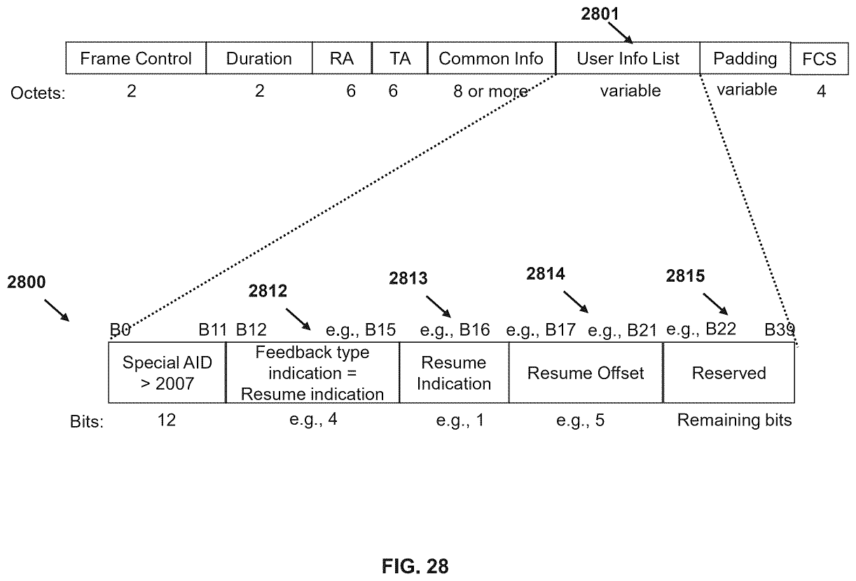

In another example embodiment, as shown in FIG. 28, the transmission resume command may be included in a Special STA info field 2800 in the User Info List 2801 of any trigger frame, such as MU-RTS, Buffer Status Report Poll (BSRP), etc., with the AID set to a value greater than 2007, and the remaining bits set as feedback info type field, for example, having a length of 4 bits, referring to a transmission resume indication information, followed by the resume offset k, the resumed PPDU expected sequence number, and a TBD reserved field of a predefined length. Such example special STA info field 2800 can be used to convey additional feedback information, such as a Feedback type indication 2812, Resume Indication 2813, Resume Offset 2814, and other TBD information 2815.

In another example embodiment, a new frame format may be defined specifically for the transmission resume command frame. This frame would include a flag bit indicating that the resumption of the paused ongoing transmission is allowed and may contain additional information elements (e.g., Resumed PPDU expected sequence number, Resume offset, etc. to facilitate resumption of the paused ongoing transmission.

Herein, the term “predefined” (for example, a “predefined” item such as a “predefined” parameter) refers to an item defined before the method disclosed herein is performed (for example, defined as a system design parameter such as defined by relevant standards).

Herein, the term “preconfigured” (for example, a “preconfigured” item such as a “preconfigured” parameter) refers to an item configured by a suitable apparatus before a certain even occurs.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

Herein, various embodiments are described. In various embodiments, the methods disclosed herein may be implemented as hardware, software, firmware, or a combination thereof, and may be implemented in any suitable form. Depending on the functionalities of various features of the methods disclosed herein, some features may be implemented on the network side (such as in one or more APs), some other features may be implemented on the STA side, and/or yet some other features may be implemented on both the AP and the STA sides. Depending on the functionalities of various features of the methods disclosed herein, some features may be implemented on the transmitting side (such as in one or more APs and/or one or more STAs for transmission), some other features may be implemented on the receiving side (such as in one or more APs and/or one or more STAs for receiving), and/or yet some other features may be implemented on both the transmitting and the receiving sides.

For example, in some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus including one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may include any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the various embodiments and/or features disclosed herein may be customized and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A method, comprising:
transmitting, by a first device in a wireless network to a second device in the wireless network, a transmission pause indication indicative of pausing, by the first device, an ongoing transmission from the first device to the second device; and
resuming, by the first device, the ongoing transmission to the second device.

2. The method of claim 1, wherein the ongoing transmission includes a physical layer protocol data unit (PPDU), pausing the ongoing transmission includes pausing transmission of the PPDU, and resuming the ongoing transmission includes resuming the transmission of the PPDU.

3. The method of claim 1, wherein the transmission pause indication includes an orthogonal frequency-division multiplexing (OFDM) symbol or an orthogonal frequency-division multiple access (OFDMA) symbol having a predefined sequence.

4. The method of claim 1, further comprising one of:
receiving a transmission pause request from a third device in the wireless network;
receiving a transmission pause request from the third device via the second device; and
receiving a transmission pause command from the second device.

5. The method of claim 1, further comprising:
receiving a transmission resume command from the second device.

6. The method of claim 1, wherein the transmission pause indication follows a first portion of the ongoing transmission transmitted by the first device to the second device.

7. The method of claim 6, wherein resuming the ongoing transmission comprises:
transmitting a transmission resume indication followed by a second portion of the ongoing transmission, the second portion being subsequent to the first portion.

8. The method of claim 7, wherein resuming the ongoing transmission further comprises:
retransmitting a predetermined portion of the first portion, the predetermined portion immediately preceding the second portion.

9. The method of claim 7, wherein the transmission resume indication includes one of:
the transmission pause indication;
a value of 1 of bit B8 of a U-SIG-2 field of a physical layer (PHY) Header for transmitting the second portion of the ongoing transmission;
a predefined value of a bit selected from bits B20 through B25 of a U-SIG-1 field of the PHY Header for transmitting the second portion of the ongoing transmission.

10. The method of claim 1, further comprising:
determining that a triggering event requires the pausing, by the first device, of the ongoing transmission from the first device to the second device.

11. The method of claim 10, further comprising:
determining, at the first device, that the triggering event is complete, wherein the resuming of the ongoing transmission follows the completion of the triggering event.

12. A method, comprising:
receiving, by a first device in a wireless network from a second device in the wireless network, a first portion of an ongoing transmission and a transmission pause indication immediately following the first portion, the transmission pause indication indicative of pausing, by the second device, the ongoing transmission from the second device to the first device;
storing the first portion in a memory of the first device; and
receiving, by the first device from the first device, a second portion of the ongoing transmission.

13. The method of claim 12, further comprising:
combining, at the first device, the first portion and the second portion to obtain a complete transmission.

14. The method of claim 12, wherein receiving the second portion comprises receiving a transmission resume indication that precedes the second portion, the transmission resume indication being one of:
the transmission pause indication;
a predetermined portion of the first portion, the predetermined portion immediately preceding the transmission pause indication;
a value of 1 of bit B8 of a U-SIG-2 field of a physical layer (PHY) Header for the second portion of the ongoing transmission; and
a predefined value of a bit selected from bits B20 through B25 of a U-SIG-1 field of the PHY Header for the second portion of the ongoing transmission.

15. The method of claim 12, wherein the ongoing transmission is a physical layer protocol data unit (PPDU).

16. The method of claim 12, wherein the transmission pause indication includes an orthogonal frequency-division multiplexing (OFDM) symbol or an orthogonal frequency-division multiple access (OFDMA) symbol having a predefined sequence.

17. The method of claim 12, further comprising one or more of:
transmitting, from the first device to the second device, a block acknowledgement (BA) message that includes a transmission pause request from a third device in the wireless network;
receiving the transmission pause request from the third device; and
transmitting, from the first device to the second device, a transmission pause command for pausing the ongoing transmission from the second device to the first device.

18. The method of claim 12, further comprising:
transmitting, from the first device to the second device, a transmission resume command.

19. The method of claim 12, further comprising:
determining, at the first device, that a triggering event requires the pausing, by the second device, of the ongoing transmission from the second device to the first device.

20. An apparatus in a wireless network, the apparatus comprising a processor and memory, the memory including machine executable instructions which when executed by the processor configure the apparatus to:
transmit, by a first device in a wireless network to a second device in the wireless network, a transmission pause indication indicative of pausing, by the first device, an ongoing transmission from the first device to the second device; and
resume, by the first device, the ongoing transmission to the second device.
